(19) United States
(12) Patent Application Publication
(10) Pub. No.: US 2025/0037161 A1
(43) Pub. Date: Jan. 30, 2025

(54) system and method for an advertising creative and audience testing platform

(71) Applicant: SweepLift Inc., Brooklyn, NY (US)

(72) Inventors: Keith Wright, San Diego, CA (US); Kemble Fletcher, San Diego, CA (US); Lee Lorenzen, Pacific Grove, CA (US); John Quinn, Boston, MA (US); Gerron Vartan, Atherton, CA (US)

(21) Appl. No.: 18/205,098

(22) Filed: Jul. 27, 2023

(51) Int. Cl. G06Q 30/0242; G06Q 30/0207

(52) U.S. Cl. CPC G06Q 30/0245; G06Q 30/0212

(57) ABSTRACT

A method for testing advertising, said method comprising the steps of: recruiting prospective survey respondents within a single online platform and collecting inputs from the respondents representing a prospective advertising audience regarding their advertising creative variant preferences and desirability as customers, combining the individual inputs from the survey respondents to compute at least one score for each pairing of audience and creative; and recommending actions based on the computed score, wherein the recommended actions include at least one of activating pairings with high preference scores and density of desirable customers; suppressing pairings with low preference scores or low density of desirable customers; or conducting another test after changing at least one of the audience or advertising creative variants, wherein the recommended actions are within the single on-line platform.

### BACKGROUND

### Field

The present invention relates to a method for optimizing online advertising. More particularly, the present invention relates to methods of surveying sample audiences to collect their reactions to a specific set of ad creative alternatives (e.g., multiple video ads, display ads, animated ads, audio ads, etc.), and scoring each person's demographic data, responses to specific screening questions, and reactions to each alternative ad to make campaign optimization recommendations based on the goodness-of-fit scores between audiences and ads.

### Related Art

The online advertising industry is facing several challenges that affect its ability to produce effective advertising campaigns. These include a lack of intra-channel testing, latency from survey to results to action, and a lack of longitudinal progress monitoring and reaction. In addition, new legislation being debated in Congress may make it difficult for advertisers to acquire certain personal information for ad targeting purposes. This creates a void in robust personal information for targeting purposes that requires a new solution, such as activating creative campaigns within identified segments with threshold-grade variant preference scores and customer viability.

Advertisements are paid promotional messages through which companies attempt to convince customers to be more favorably disposed to purchasing their products. Advertisements take many forms including print ads, radio ads, television ads, online ads, in-store display and audio advertisements, billboards, etc. Producing and disseminating these advertisements is expensive. Companies wish to maximize the impact of their advertisements by determining the most effective message to promote. Numerous marketing textbooks and classes discuss this field.

Over the past 20+ years, online advertising in which ads are shown to website visitors and/or mobile application users has become a $500+ billion-dollar industry. The online ads shown to users can be in response to a web search or based on users' web browsing or app usage. In some advertising platforms (e.g., Facebook, YouTube, TikTok, Twitter, Amazon, etc.), it is possible to programmatically choose which audiences will see a given ad. The online ad industry refers to a particular pairing of programmatic audience with an ad creative as an ad campaign and these ad campaigns are activated on the platforms when advertisers agree to spend a certain amount of ad budget on each campaign.

One of the major obstacles to creating effective advertising is determining a customer's likely response to a particular advertisement. Traditionally companies have used focus groups and/or offline surveys to obtain customer response information about their products and/or advertisements. This information can then be used to adjust, replace or reconfigure their audiences, advertisements, and other ad campaign variables. Unfortunately, these techniques for generating customer response information are expensive, limited in scope, and often non-predictive of the ad campaign's ultimate performance. One of the main reasons is that the surveys used to evaluate an audience's preference for a given ad creative are not conducted “in-platform.” In other words, the online survey lacks fidelity because it is not using the same ad format, not sampling an audience by using the same programmatic filters, and not running the recruitment ad campaign in the same platform (e.g., Facebook, YouTube, TikTok, Twitter, etc.) in which the ad campaign for a specific ad, audience and platform will ultimately be activated. Therefore, there is a need and opportunity—before spending large amounts of an ad budget—for a new method of generating customer response information that is inexpensive, conducted with an in-platform audience sample and offering better predictions of an ad campaign's effectiveness.

Another problem with improving the effectiveness of advertising is the significant time delay between obtaining the customer response data, selecting a specific audience, choosing the appropriate ad creative, and activating the ad campaign. In many circumstances, the initial data indicating what will be effective in advertising a particular product may become inaccurate or obsolete if it is not discovered during a pre-testing process that can directly evolve into a scaled ad campaign. This means that testing that happens in parallel with the running of the ad campaign (or worse yet after) will be of limited value compared to pre-testing the ad.

Another problem related to the time it takes to conduct traditional ad testing is that it does not allow for the entire process of progressive learning that is necessary to optimize an ad campaign to be conducted in a short period of time for a minimal cost. Matching of ads to creative is inherently an evolutionary process where improvements suggested by one test can then be used to guide future improvements that likewise require validation via a subsequent test. To make this practical, the cost in time and money of each test needs to be low relative to the potential savings of not showing the wrong ad to the wrong audience and/or increased effectiveness and increased profits of showing the right ad to the right audience.

The advertising industry is facing yet another obstacle as the push for stronger consumer privacy on the Internet gains momentum. With more states implementing stricter privacy laws, Congress is currently deliberating on a bill that is heavily influenced by a California law. This bill is expected to have a significant impact on the way consumers engage online, as well as ending the covert collection of data related to those interactions. A sea change in the online advertising industry is on the horizon.

In general, a federal data privacy framework would likely impact online advertising by placing restrictions on the collection, use, and sharing of personal information, including personal purchasing habits or standards. The specific types of personal information that could be collected and how this is accomplished would depend on the details of the framework, but it is likely that there would be limitations on the amount and type of personal information that could be collected without explicit user consent. The protections offered to consumers would also depend on the details of the bill, but could include the right to access and delete personal information, the right to opt out of certain types of data collection or sharing, and requirements for companies to be transparent about their data practices.

Some objections to data privacy legislation come from technology and ad platform companies, who may argue that the regulations would be too burdensome or could harm their ad-platform business model. However, consumer privacy advocates argue that strong data privacy protections are necessary to protect individuals from unwanted data collection and sharing. Technology and ad platform companies may attempt to find ways to collect and use personal information for targeted advertising within the bounds of the law, such as by obtaining explicit user consent for data collection or using anonymized data. By using broad categories of user characteristics, such as age, gender, and interests, companies can deliver targeted ads while respecting users' privacy rights. This type of segment-targeted advertising-targeting specific audience segments rather than individual users-may be a time and cost-effective solution to these challenges by incorporating some combination of in-platform audience sampling, targeted surveys, and data analysis to better predict the effectiveness of their ad campaigns. This could help companies to optimize their ad targeting and maximize the efficiency of their ad spend in a world where the consumer owns their information.

In this new, uncharted environment where hazards abound, it is becoming increasingly evident that there is a pressing need to match each audience segment with the appropriate ad creative. While some products are bought by a broad range of customers, like toilet paper and toothpaste, others are purchased by particular groups, such as cat food. Advertisements for narrow-use products lose effectiveness when displayed to a generic group of customers, leading to significant losses in advertising efficiency. Consequently, the industry needs a process to identify the target group for specific advertisements, enabling them to optimize the efficiency of ad campaigns. Existing post-facto ad testing tools may not save advertisers from drowning in ad wastage, making an audience-scored and targeted approach even more necessary for both consumers and advertisers.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Embodiments disclosed include an automated pipeline for surveying and measuring the individual advertisement preferences of sample groups of customers (audience, segment, or group with aligned attributes) who are selected from online audiences using an ad platform's specific taxonomy.

The present invention relates to a system and method for testing advertising, which includes collecting inputs from prospective survey respondents representing a prospective advertising audience regarding their advertising creative variant preferences and desirability as customers and combining the individual inputs from the survey respondents to compute at least one score for each pairing of audience and creative. The recommended actions include activating pairings of high preference scores and density of desirable customers, suppressing pairings with low preference scores or low density of desirable customers, or conducting another test after changing at least one of the audience or advertising creative variants.

In one embodiment, a processor coupled to a non-transitory storage element with encoded instructions to the processor, wherein the encoded instructions when implemented by the processor, configure the system to: scoring audience member attributes and responses to at least one or a plurality of creative variants in order to determine the most impactful pairing of creative variant and audience. The system/processor further comprises a survey module facilitates recruiting prospective survey respondents—collectively representing a prospective advertising audience—within a single online platform by using a programmatic filter to target individuals with characteristics matching the desired audience profile. The inputs collected from survey respondents regarding advertising creative variant preferences are gathered through a survey that presents the respondents with at least a series of advertising options and asks them to indicate their preferred option. Once all of the inputs are collected, a scoring module facilitates collecting those inputs regarding their advertising creative variant preferences and desirability as customers in order to compute at least one score for each pairing of audience and creative. The score computed from the inputs combines the proportion of respondents who preferred a given advertising creative variant with the density of desirable customers in that audience. Other scores reflecting other variant and, or consumer attributes are possible, by any number of scoring methods, in order to find the combination that optimally pairs creative with audience. Once scored, a recommendation module facilitates recommending actions based on the computed score and pre-defined or dynamic (learned) thresholds, wherein the recommended actions include at least one of activating pairings with high preference scores and density of desirable customers; suppressing pairings with low preference scores or low density of desirable customers; or conducting another test after changing at least one of the audience or advertising creative variants.

In yet another embodiment, in addition to analyzing survey responses and generating scores, the system can cross-reference the computed scores with external market data to provide a more contemporaneous or fully-informed prediction of campaign performance. This can help marketers make informed decisions about where to allocate their resources and how to adjust their strategies.

In one object of the present disclosure, the system may also optimize the timing and placement of the advertising campaign by analyzing the input, along with exogenous sources, including for meta-device/session data, and external market data. For example, if the target audience who most prefers a given creative variant is highly active on social media during certain hours of the day, the system might suggest running the ads during those times. By taking advantage of these patterns, marketers can increase the likelihood of reaching their target audience at the right time and place with the best performing creative.

Perhaps most importantly, it is another object of the present disclosure to provide a system that may monitor the effectiveness of the advertising campaign over time and provide ongoing feedback/recommendations to help improve its effectiveness. By tracking engagement metrics such as click-through rates, conversion rates, and sales data, the system can provide insights into what's working and what's not in terms of the pairing of audience and creative, allowing marketers to make data-driven decisions to activate and scale campaigns. Finally, in other aspects, the system may be able to score variants without respondent input, but rather predictively based on deep-learned insights. The scores, may, in turn, prompt the same series of activate/scale recommendations based on the same score criteria, as with the survey-scored system. The visual features of a new advertising variant can be compared to the visual features of previously scored variants using traditional computer vision techniques. Only the scores of the previously scored variants that are aligned with the new variant are used to calculate the score of the new variant. Introducing an all-new survey platform integrated with an advertising channel to maximize advertising effectiveness.

Other aspects and advantages of the invention will be apparent from the following description and the appended claim

### BRIEF DESCRIPTION OF THE DRAWINGS

The drawings illustrate the design and utility of embodiments of the present invention, in which similar elements are referred to by common reference numerals. In order to better appreciate the advantages and objects of the embodiments of the present invention, reference should be made to the accompanying drawings that illustrate these embodiments. However, the drawings depict only some embodiments of the invention, and should not be taken as limiting its scope. With this caveat, embodiments of the invention will be described and explained with additional specificity and detail through the use of the accompanying drawings in which:

FIG. 1a illustrates in a block diagram, the advertising creative and audience testing platform, according to an embodiment.

FIG. 1b illustrates in a block diagram, the advertising creative and audience testing platform, according to an embodiment.

FIG. 2 illustrates in a block diagram, the advertising creative and audience testing platform, according to an embodiment.

FIG. 3 illustrates in a block diagram, the advertising creative and audience testing platform, according to an embodiment.

FIG. 4 illustrates in a method flow diagram, the advertising creative and audience testing platform, according to an embodiment.

FIG. 5 illustrates in a method flow diagram, the advertising creative and audience testing platform, according to an embodiment.

FIG. 6 illustrates in a graphical process flow diagram, the advertising creative and audience testing platform, according to an embodiment.

FIG. 7 illustrates in a screenshot, a function of the advertising creative and audience testing platform, according to an embodiment.

### DETAILED DESCRIPTION

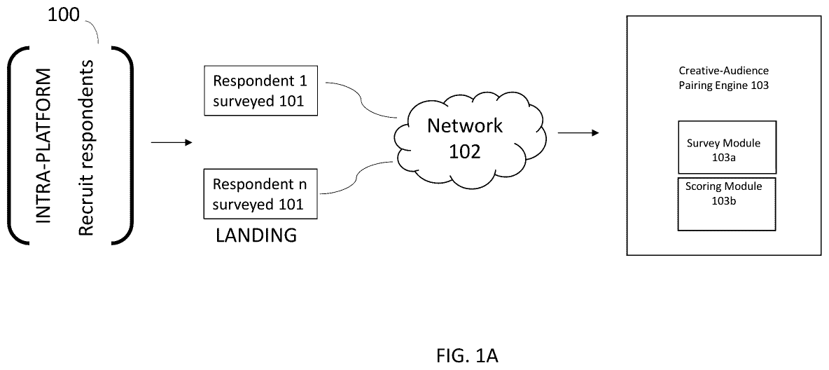

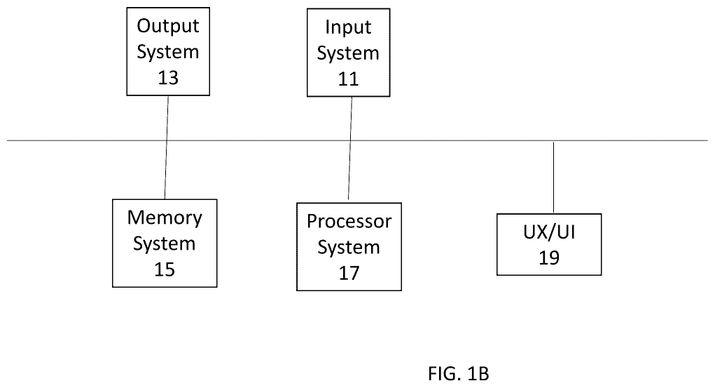

Specific embodiments of the invention will now be described in detail with reference to the accompanying FIGS. 1-6. In the following detailed description of embodiments of the invention, numerous specific details are set forth in order to provide a more thorough understanding of the invention. In other instances, well-known features have not been described in detail to avoid obscuring the invention. Embodiments disclosed include a system and method for scoring respondents for optimal pairing with a creative variant among a choice of creative variants.

The figures illustrate the architecture, functionality, and operation of possible implementations of systems, methods and computer program products according to various embodiments of the present invention. It should also be noted that, in some alternative implementations, the functions noted/illustrated may occur out of the order noted. For example, two blocks shown in succession may, in fact, be executed substantially concurrently, or the blocks may sometimes be executed in the reverse order, depending upon the functionality involved.

Since various possible embodiments might be made of the above invention, and since various changes might be made in the embodiments above set forth, it is to be understood that all matter herein described or shown in the accompanying drawings is to be interpreted as illustrative and not to be considered in a limiting sense. Thus, it will be understood by those skilled in the art that although the preferred and alternate embodiments have been shown and described in accordance with the Patent Statutes, the invention is not limited thereto or thereby.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it is to be understood that references to anatomical structures may also assume image or image data corresponding to the structure. For instance, extracting a teeth arch translates to extracting the portion of the image wherein the teeth arch resides, and not the literal anatomical structure.

### Definitions of Terms

The term “advertisement” encompasses all types of advertising, such as audio, video, visual, touch, taste, smell, or any combination of these. An “optimally-paired advertisement” is an ad that has been tailored for a specific target audience. “Advertising creative preference” are various factors that influence how an ad is perceived, such as tone, message, pace, aesthetic, characters, and other components. “Advertising creative variant” is any creative stimuli or ad version played for the purposes of obtaining reaction or response data. An “audience” or “audience segment” is a group of people who share at least one characteristic and a potential target for a particular ad. “Recruit” is the outreach involved in finding prospective survey respondents. “Survey respondents” are those who participate in the survey. “Single on-line platform” is a reference to the plurality of respondents found on the same on-line platform, such as Facebook or any other social network, for instances. “Landing page” refers to the site where the survey respondents, once consenting to participate, answer the survey questions. “Survey” is one or a series of questions relating to a respondent advertising creative preference and, or desirability as a customer based on reaction or response to at least one advertising creative variant and, or at least one question related to a demographic attribute. A “score” is a measurement used to gauge an advertising creative preference (sometimes referred to as variant preference) and, or customer desirability. “Media” refers to the various channels or platforms through which an ad is broadcast, including audio, visual, and in-store or out-of-store media.

Relative Preference is a measure of the proportions of the respondents from a sample audience who share similar characteristics (e.g., age, gender, location, etc.) and who prefer the same various creative variants. For example, the relative preference for men in the audience between three videos is 80% prefer video 1, 10% prefer video 2, 10% prefer video 3; and the relative preference for women in the audience between three videos is 20% prefer video 1, 15% prefer video 2, 65% prefer video 3.

FIG. 1 illustrates an exemplary network diagram of the Advertising Creative-Audience Pairing (CAP) Testing Platform. The network diagram referenced by numeral 102 comprises of a network infrastructure that is communicatively coupled to a Creative-Audience Pairing (CAP) Engine 103. The CAP Engine 103 is further comprised of a survey module 103a and a scoring module 103b. In one embodiment, the purpose of the Engine 103 is to test advertising by collecting inputs from survey respondents 101 within a single online platform (alternatively, or optionally, across heterogenous online platforms) and using these inputs to compute at least one score for each pairing of audience and advertising creative variant (single or variety of advertising variations of similar brand/product to be tested for audience scoring). In one embodiment, the Engine 103 is communicatively coupled to recruit 100 survey respondents 101 through various incentive methods such as prize offers, sweepstake entries, etc., through a single on-line channel 100.

The survey module 103a is responsible for collecting inputs from the survey respondents 101 (based on survey questions presented on a landing page, away from the channel) regarding their advertising creative variant preferences and desirability as customers. These inputs may include demographic data, psychographic data, and other relevant information about the respondents. The scoring module 103b is responsible for combining the individual inputs from the survey respondents 101 to compute at least one score for each pairing of audience and advertising creative variant. The computed scores represent the preferences of the surveyed audience regarding the advertising creative variants. Based on the computed scores, the Engine 103 recommends actions to improve the advertising effectiveness, to be implemented on the same single on-line platform. The recommended actions may include activating pairings with high preference scores and density of desirable customers, suppressing pairings with low preference scores or low density of desirable customers, or conducting another test after modifying at least one of the audience or advertising creative variants.

The scoring module 103b, in contrast, is responsible for using statistical and weighted measures to compute scores that reflect both consumer attributes and variant preferences. These scores can be used to assess customer desirability, variant sentiment, or to validate the surveying and scoring methodology and results. The scoring module can compute a single score, or a plurality of scores, along any number of consumer and variant dimensions using any number of statistical, weighted measures. These scores can represent a customer desirability score (C.D.), a variant preference score (V.P.), a single, cumulative, super composite score to reflect both scores (Fit Score), or a score to validate the surveying and scoring methodology and results (Media Score).

The network architecture supporting the CAP Testing Platform is not limited to any specific type of network. The network 102 can be any suitable wired or wireless network, or a combination of both. It may include LAN or wireless LAN connections, Internet connections, point-to-point connections, or any other network connection. The network 102 can transmit data between host computers, personal devices, mobile phone applications, video/image capturing devices, video/image servers, or any other electronic devices. It can be a local, regional, or global communication network, including enterprise telecommunication networks, the Internet, global mobile communication networks, or any combination of similar networks. The network 102 can also include software, hardware, or computer applications that facilitate the exchange of signals or data in any format known in the art, related art, or developed in the future. If the network 102 includes both an enterprise network and a cellular network, suitable systems and methods are employed to seamlessly communicate between the two networks. For instance, a mobile switching gateway may be used to communicate with a computer network gateway to pass data between the two networks.

FIG. 1B showcases a standard bus diagram for the CAP Testing Platform. A bus diagram is a type of computer network topology that uses a single cable to connect multiple devices in a linear fashion. The diagram illustrates the interconnectedness of the components of the platform, which include the memory system 15, processor system 17, input system 11, output system 13, and UX/UI system 19. The memory system 15 plays a crucial role in storing and retrieving information related to creative asset or variant preference scoring data, as well as customer desirability scoring data. This data includes creative variants, survey questions, responses, charts, reports, and other related information that is used to determine the effectiveness of a particular creative-audience pairing.

The processor system 17 is responsible for processing the stored data and generating scores that are used to determine the most effective creative-audience pairings. These scores are based on a range of factors, including the performance of past creative assets and the attributes of the target audience. In some embodiments, the input system 11 is used to receive input data and information related to prospective or past creative assets and audience attributes, including variant preference and customer desirability scores. This information is used to further refine the scoring process and ensure that the most effective creative-audience pairings are identified. The output system 13 presents the results of the scoring module output in the form of an action chart, which provides recommendations for the best creative-audience pairings. This chart may also include other graphically-driven functional tools such as activating an advertising campaign, suppressing an advertising campaign, or further exploring the recommended creative-audience pairing. The UX/UI system 19 provides an intuitive and interactive interface for users to navigate the action tools using any standard pointing device control. This interface is designed to be user-friendly and easy to navigate, ensuring that users can quickly and efficiently identify the most effective creative-audience pairings and take action accordingly. Overall, the bus diagram serves as a useful tool for visualizing the interconnectedness of the various components of the CAP Testing Platform, and how they work together to identify and recommend the most effective creative-audience pairings.

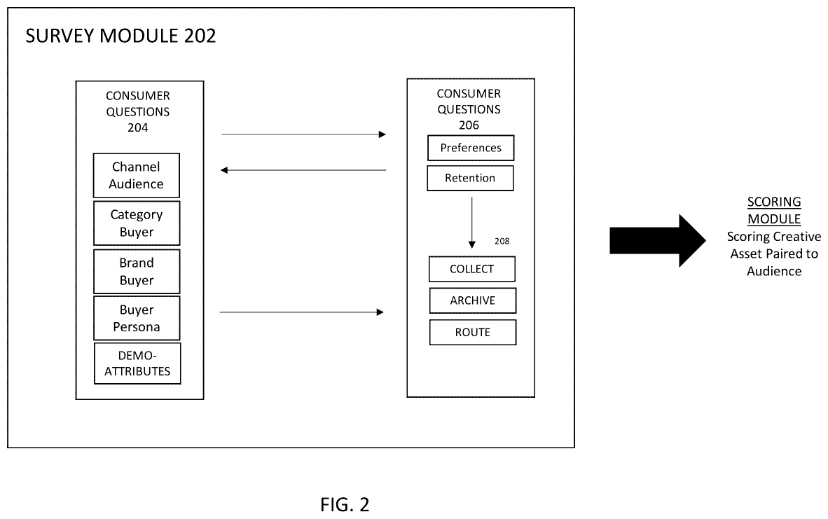

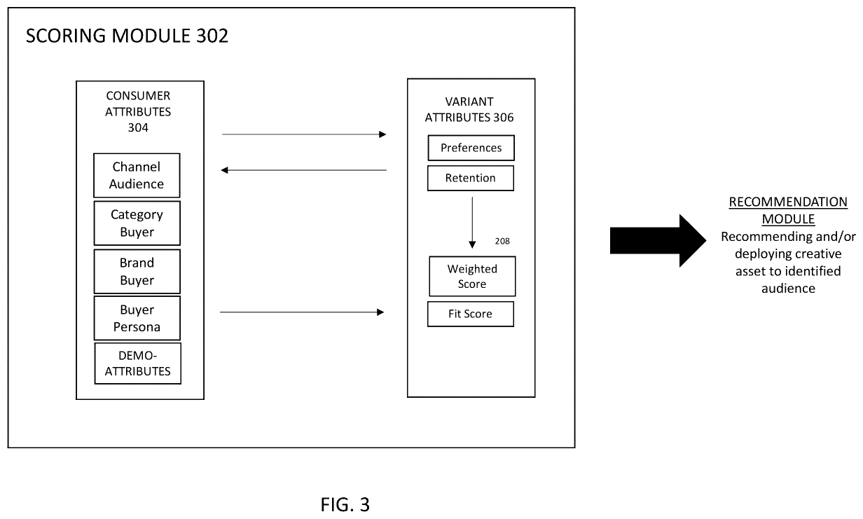

Now in reference to FIG. 2 and FIG. 3, each illustrating a system flow diagram in block form, representing an exemplary survey module 202 and scoring module 302, respectively. The system comprises, while not depicted, an input event, a memory unit in communication with the input event, and a processor in communication with the memory unit. As depicted, the processor further comprises a survey module 202 and and a scoring module 302, configured to perform the steps of: (1) collecting survey data from online survey respondents, wherein said survey data includes the respondents' reaction to each advertising variant and their attributes; and (2) computing scores based on the survey data and making recommendations for an advertising campaign, wherein said scores are computed by analyzing the survey data using a statistical analysis tool and comparing the scores for each variant and audience to determine the most optimal pairing of variant with audience.

The method for audience-scoring described involves using online surveys to collect data from respondents, which includes their reactions to each advertising variant and their personal attributes. The collected data is then used to compute scores using statistical analysis tools, which are used to make recommendations for an advertising campaign. The first step in this method involves recruiting prospective survey respondents (intra-channel) via programmatic filters and any number of incentives to participate and collecting data through curated online surveys in a non-channel/landing page. This process involves designing a survey that asks respondents about their reactions to different advertising variants and collecting their personal attributes. The personal attributes can include demographic information such as age, gender, and location, as well as psychographic data like interests, hobbies, and lifestyle choices 204. Variant preference questions may include questions related to variant preference, likeability, and retention (how long and to what extent did the respondent engage the creative variant?) 206. Some examples of attribute-deriving questions may be: “How much did you like the advertising that you selected as your preferred variant?” or “On a scale of 1-5, how likely are you to purchase the product after seeing this advertising variant?” Questions may be of the single-choice variety (do you own a cat?, for instance), multiple choice (which cat food brand do you normally purchase, Kibbles, Purina, etc.?), open-ended (mention two things you prefer about your preferred brand?), rank-order (rank the brands based on your experience?), or on a numerical scale (rate the ad variant you chose as your favorite?).

The survey function is composed of various sub-modules 204, 206, 208 that allow the system to solicit potential participants through a single online channel using programmatic filters. To encourage participation, respondents may be offered a prize or sweepstakes entry. If accepted, the respondent will be redirected to the system's landing page where they will answer a set of questions that will eventually be scored by the scoring module. The scores will indicate the preferences for advertising creative variants and customer desirability, as well as screen the programmatic audience for recommendations on pairing creative variants and audience segments.

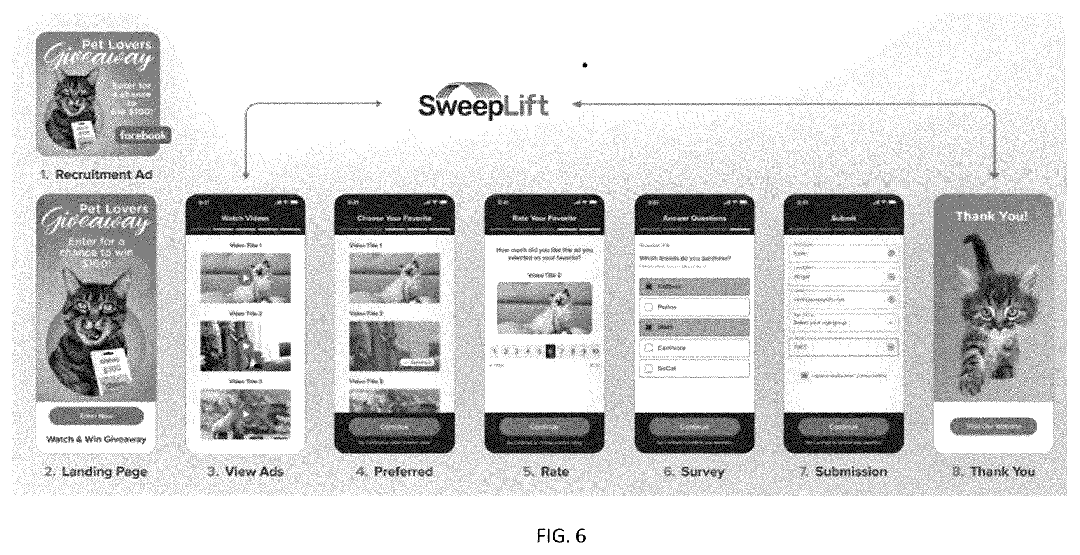

FIG. 3 highlight the processor/scoring module 302 in more detail, detailing the individual modules within it and/or those that interact between them. In an embodiment, the memory unit is a non-transitory storage element that stores encoded information. When implemented by the processor, the encoded instructions configure the system to receive at least one survey response related to at least one consume/variant attribute to: recruit survey respondents within an online platform and collect inputs from the respondents representing a prospective advertising audience regarding their advertising creative variant preferences 306 (preference, likeability, and retention) and desirability as customers 304, combining the individual inputs from the survey respondents to compute at least one score for each pairing of audience and creative 308; and recommend actions based on the computed score, wherein the recommended actions include at least one of activating pairings with high preference scores and density of desirable customers; suppressing pairings with low preference scores or low density of desirable customers; or conducting another test after changing at least one of the audience or advertising creative variants (FIG. 6, illustrating an exemplary graphical process flow in accordance with an aspect of the invention, further highlighting the Score Chart 607/Action Chart 608, generated by the scoring module 302).

As depicted in FIG. 3, the scoring may employ statistical analysis tools to compute scores based on the survey data. This can include using tools like regression analysis or factor analysis to identify patterns and relationships between the survey responses and the personal attributes of the respondents. By analyzing the survey data in this way, it is possible to identify which advertising variant resonates most strongly with which type of audience (CAP-mediated audience screening or segmentation). Economic targets such as category buyers, brand buyers, buyer frequency, buyer purchase amount, and buyer lifespan 204, 304 provide insight into a customer's purchasing behavior and preferences. By understanding these economic targets, companies can identify their most valuable customers and develop targeted marketing campaigns to retain them. For example, a company may use a survey to understand which product categories or brands their customers are most interested in, and use that information to develop targeted promotions or product recommendations.

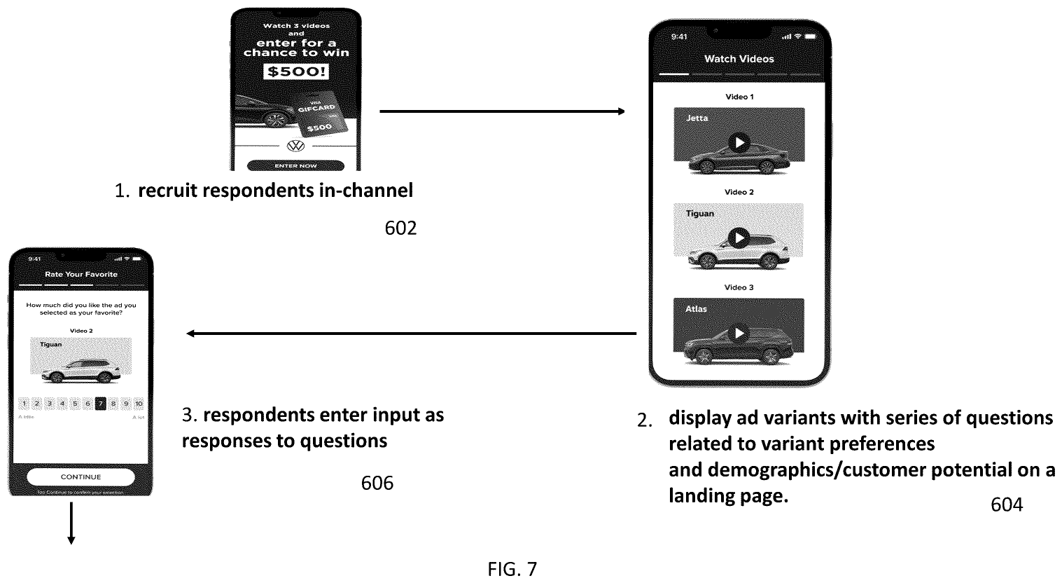

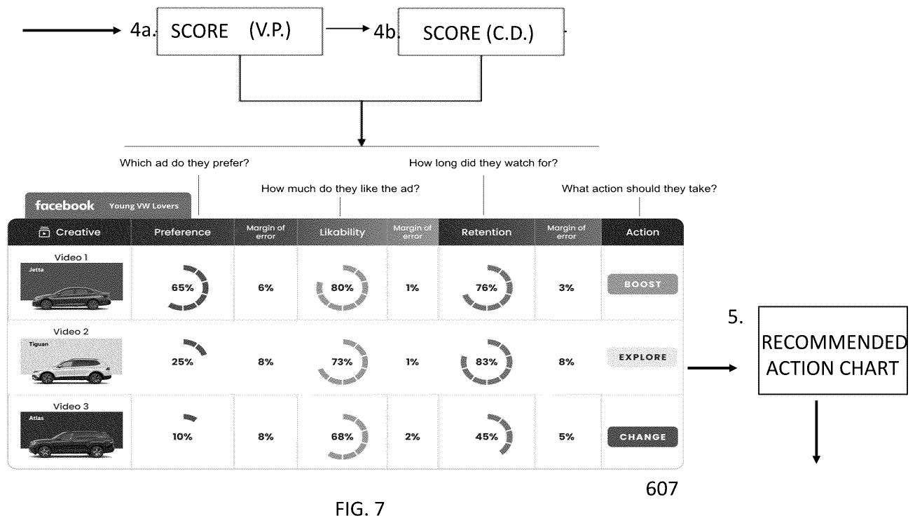

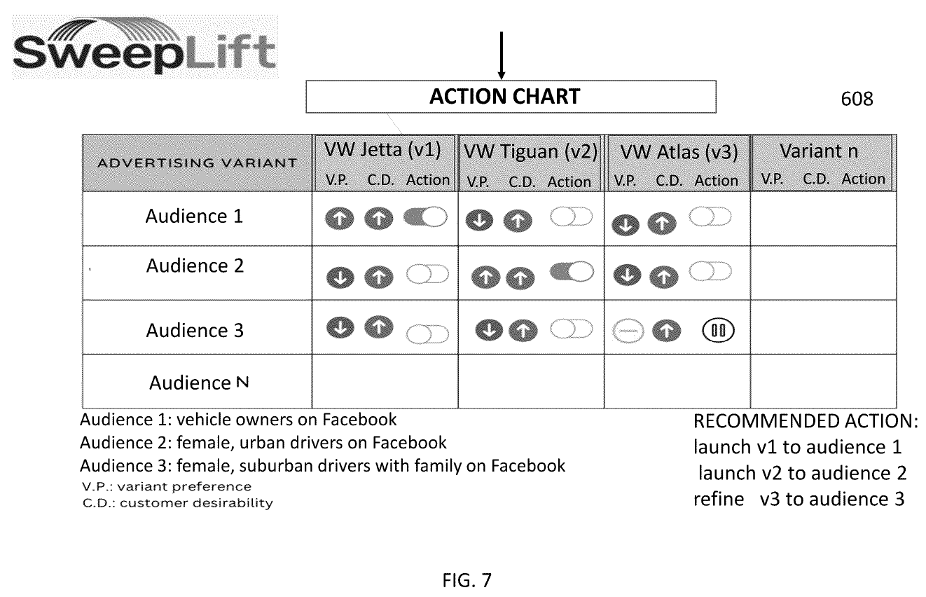

Demographic targets such as age, gender, occupation, location, meta device/session data, etc. 206, 306 help companies understand the characteristics of their customer base. By understanding these demographic targets, companies can tailor their marketing messages and product offerings to better resonate with their target audience. For example, a company may use a survey to understand the age and gender of their most frequent buyers, and use that information to develop targeted messaging or product designs. Overall, beyond the score chart and action chart (recommendations), a suite of other assets and key insights may be generated from the CAP Testing, such as executive summaries, initiating progressive learning, designing creative testing strategies based on the segmentation insights, prioritizing testing, scheduling periodic testing, and other key insights (FIGS. 7 and 8 each illustrate by way of screenshots, exemplary functions and types of key insights generated by the CAP Testing Platform, in addition to the scoring and recommending described earlier).

Another implementation of the current invention involves scoring respondents based on their Creative Preference, with weights assigned to each score depending on the perceived importance of the various factors that are expected to impact their response to an ad campaign. For instance, a respondent from a specific online audience may be asked to watch three video ads, and the invention will survey which video is most preferred, how much they liked it on a scale of 1 to 10, and how much of the video they viewed before skipping to the next one or completing the process. While all these measures are relevant to creative preference, they may not carry equal weight, and therefore a weighting of these factors is used to score the level of Creative Preference for the proportion of the audience that favored a particular video.

Another embodiment of the invention relates to scoring respondents based on Screening Questions, with weights assigned to each score depending on the perceived importance of the various factors that are expected to impact their response to an ad campaign. For example, a respondent from a specific online audience may be asked a series of questions, such as their brand of product usage, income range, and their opinion on the economy, and other questions relevant for measuring how well-matched a given programmatic audience is with the persona and attributes of the advertiser's target customers. While these measures relate to the goodness-of-fit between the audience and the ad, they may not carry equal weight, and therefore a weighting of these factors is used to score the Screening Questions for both the audience as a whole and the proportion of the audience that favored a particular video.

Another implementation of the invention involves scoring respondents based on their Potential Lifetime Value (LTV), with weights assigned to each score depending on the perceived importance of the various factors that are expected to impact their response to an ad campaign. For instance, a respondent from a specific online audience may be asked questions related to their current and future likelihood of buying a product and contributing to the advertiser's revenue and profits. While these measures relate to the lifetime value of the respondent, they may not carry equal weight, and therefore a weighting of these factors is used to score the Potential Lifetime Value for both the audience as a whole and the proportion of the audience that favored a particular video. The invention also involves scoring respondents based on their Desirability, which is computed as a weighted combination of the scores for each respondent's Creative Preference, Screening Questions, and Potential LTV. This Desirability score can then be used to help advertisers or analysts focus their attention on the next steps in ad campaign optimization and avoid missing key patterns in the large volume of results.

### Exemplary Process

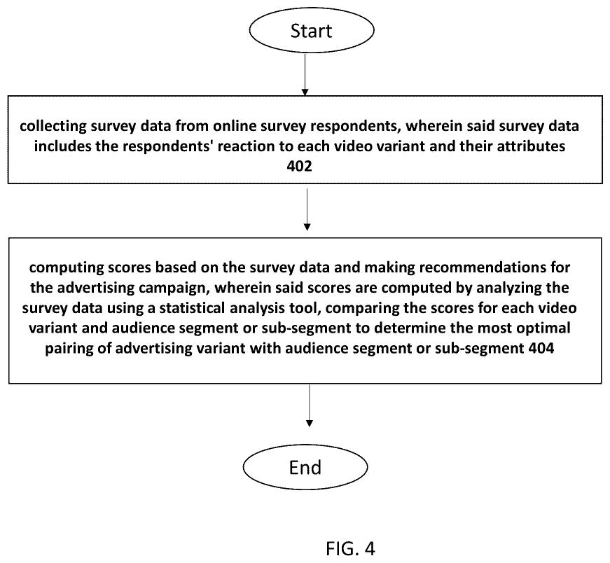

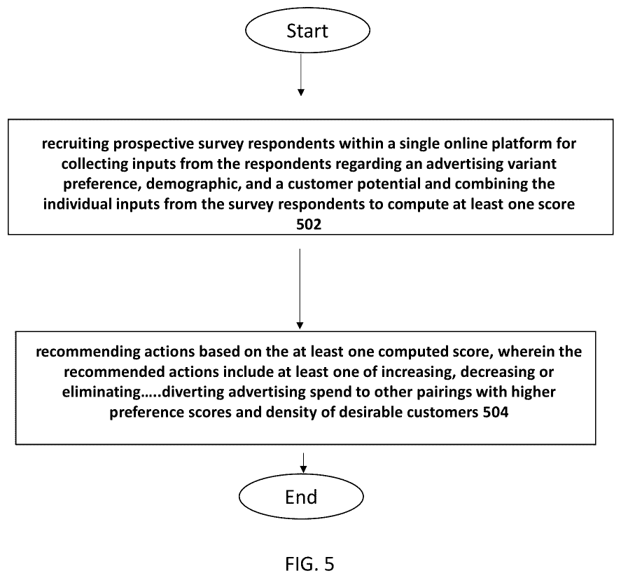

Now in reference to FIGS. 4 and 5, which each illustrate a method flow diagram of an exemplary embodiment, and FIG. 6, which illustrates a graphical process flow diagram of an exemplary scenario. The method/process can be performed in any order in relation to one another, and in one embodiment, the method comprises recruiting prospective survey respondents within a single online platform for collecting inputs from the respondents regarding an advertising variant preference, demographic, and a customer potential and combining the individual inputs from the survey respondents to compute at least one score 402, 502; and computing scores based on the survey data and making recommendations for the advertising campaign, wherein said scores are computed by analyzing the survey data using a statistical analysis tool, comparing the scores for each video variant and audience segment or sub-segment to determine the most optimal pairing of advertising variant with audience segment or sub-segment 404, 504.

FIG. 6 is a visual representation of a method for testing advertising, which is designed to identify the most suitable advertising creative variant for a specific audience segment. The process involves recruiting survey respondents from an online platform (intra-platform) and collecting their inputs regarding their preferences for different advertising creative variants, as well as their desirability as customers. The individual inputs are then combined to compute scores, or a score, for each pairing of audience and creative. The resulting scores are used to recommend actions, such as activating pairings with high preference scores and density of desirable customers, suppressing pairings with low preference scores or low density of desirable customers, or conducting another test after changing at least one of the audience or advertising creative variants.

In FIG. 6, Step 1 shows a Pet Lovers Giveaway for a chance to win $100 From Facebook, a popular social media platform. Steps 2-3 brings the audience to the landing page of the advertisement for entering a chance to win $100 chewy gift card for watching cat videos, displaying three different creative advertising variants for cats on a dedicated landing page and Step 4 asks the respondents to pick their preferred video from the three videos shown, Steps 5 shows rating the three videos by the respondents and step 6 shows respondents entering their input as responses to the survey questions. Steps 4-6 are critical steps, as it involves scoring the various customer desirability and variant preference metrics for each advertising creative variant across each audience segment. Steps 7 and 8 show submission of the respondent information and a final thank you page.

In FIG. 7, Step 1 shows the recruitment of survey respondents from Facebook, a popular social media platform 602. Step 2 involves displaying three different creative advertising variants for Volkswagen cars (Jetta, Tiguan, and Atlas) on a dedicated landing page once prospective respondents provide consent for participating, along with questions targeting customer desirability (C.D.) and variant preference (V.P.) 604. Step 3 shows respondents entering their input as responses to the survey questions 606. Step 4 is a critical step, as it involves scoring the various customer desirability and variant preference metrics for each advertising creative variant across each audience segment. The scoring chart (607) indicates the calculates scores for each pairing of audience and creative. The scores are based on a variety of factors, such as the level of interest in the advertising variant, the attractiveness of the advertising to the audience segment, and the demographic characteristics of the audience segment. Finally, Step 5 involves recommending actions based on the segmented scores. For example, in this scenario, the first creative variant (VW Jetta variant) is recommended for activation at scale for audience segment designated as 1, which corresponds to all Facebook users who own or drive cars. Variant 2 (VW Tiguan) is recommended for launch to audience segment 2, which corresponds to urban female drivers. Variant 3 (VW Atlas) is recommended for pause in segment 3, which corresponds to female suburban drivers with families, based on the non-definitive, but potentially promising scores from the scoring module.

FIGS. 6 and 7 illustrates a comprehensive method for testing advertising, which enables the identification of the most suitable advertising variant for each audience segment. By leveraging data-driven insights, this method helps advertisers to optimize their advertising campaigns, achieve higher engagement rates, and ultimately drive better business outcomes.

In another embodiment, advertising content creation may be defined based on the CAP Testing Platform customer response data. Once enough customer response data has been obtained or generated, the next step is to identify the advertising target group. This group is identified manually or automatically based on the current customer population of a store at a particular time. Once the advertising target group is identified, an advertisement is generated with optimized advertising variable settings. This process involves using the optimum advertising variable settings for the target advertising group to generate an advertisement that appeals to that group. The generated advertisement may include one or flexible advertising variable settings, such as volume and frequency, depending on the objectives of the advertising company. Some advertising variable settings require additional content to allow for flexibility, such as price quotes, gender of speaker, seasonal greetings, etc. This additional content is known as advertising components.

Once the optimized advertisement is generated, it is broadcast. Broadcasting the advertisement includes all forms of exposing the public to the advertisement, including hanging a poster, playing an audio track, playing a video track, distributing a smell, or any combination thereof. The broadcasting of the advertisement needs to be consistent with the optimized set of variables, including the time of day and location. The advertisement may also be broadcast at additional non-optimized times or locations as a test advertisement for obtaining more customer response data.

Utilizing customer response data can also optimize advertising and aid advertisers in determining their media spending across various forms. Metric values, such as reach, frequency, sales, and awareness, provide valuable insights into how specific media affect customers. Various techniques, including customer response devices and data processes, can be employed to extrapolate metric values from other information. By identifying the metrics linked with different media, the most effective media combinations for specific messages and advertisements can be determined. RF curves, which illustrate customer response to particular media forms, offer crucial information on metric values. These curves go beyond analyzing individual curves and can be used to identify an inflection point and a range at which it's efficient to advertise through media. It's possible to use any metric value instead of the RF value on each curve, and combination curves can also provide insights into the effects of combined media.

Some portions of embodiments disclosed are implemented as a program product for use with an embedded processor. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive, solid state disk drive, etc.); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-accessible format and hence executable instructions. Also, programs are comprised of variables and data structures that either reside locally to the program or are found in memory or on storage devices. In addition, various programs described may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

The present invention and some of its advantages have been described in detail for some embodiments. It should also be understood that various changes, substitutions and alterations can be made herein without departing from the spirit and scope of the invention as defined by the appended claims. An embodiment of the invention may achieve multiple objectives, but not every embodiment falling within the scope of the attached claims will achieve every objective.

Moreover, the scope of the present application is not intended to be limited to the particular embodiments of the process, machine, manufacture, and composition of matter, means, methods and steps described in the specification. A person having ordinary skill in the art will readily appreciate from the disclosure of the present invention that processes, machines, manufacture, compositions of matter, means, methods, or steps, presently existing or later to be developed are equivalent to, and fall within the scope of, what is claimed. Accordingly, the appended claims are intended to include within their scope such processes, machines, manufacture, compositions of matter, means, methods, or steps.

I/We claim:

1. A method for testing advertising, said method comprising the steps of:
recruiting survey respondents within a single online platform in which an advertising campaign has been, is currently or may be activated;
collecting inputs regarding the recruited respondents' advertising creative preferences and desirability as customers based on at least one response to at least one advertising creative variant and/or at least one question;
combining the individual inputs from the survey response to compute at least one score for each pairing of audience and advertising creative variant; and
recommending actions based on the computed score, wherein the recommended actions include at least one of: activating pairings with high preference scores or density of desirable customers; suppressing pairings with low preference scores or low density of desirable customers; or conducting another test after changing at least one of the audience and/or advertising creative variant, wherein all recommended actions are within the same online platform.

2. The method of claim 1, wherein respondents are recruited by using a programmatic filter in a single on-line platform to target individuals with characteristics matching the desired audience profile.

3. The method of claim 2, wherein the programmatic filters used to recruit survey respondents include targeting based on age, gender, location, interests, and other demographic or psychographic factors.

4. The method of claim 1, wherein a sweepstake offer is sent to prospective survey respondents as an incentive to participate in the survey.

5. The method of claim 1, wherein the inputs collected from survey respondents regarding advertising creative preferences are gathered through a survey that presents the respondents with a series of advertising options and asks them to indicate their preferred option.

6. The method of claim 1, wherein the inputs collected from survey respondents regarding demographic and/or customer desirability relate to at least one of the respondents age, gender, nationality, race, income, occupation, purchasing behavior, viewing habits, location of residence, or meta-data.

7. The method of claim 1, wherein the inputs collected from survey respondents related to customer potential are further gathered through a combination of survey questions and data analysis of the respondents' self-reported or derived purchasing behavior.

8. The method of claim 1, wherein the score computed from the inputs combines the proportion of respondents who preferred a given advertising creative variant with the density of desirable customers in that audience (fit score).

9. The method of claim 1, wherein the score computed from the inputs combines the proportion of respondents who preferred a given advertising variant with the density of undesirable customers in that audience segment.

10. The method of claim 1, wherein the score computed from the inputs compares the relative preference for different advertising variants within a specific audience based on factors such as age, gender, location, or other relevant characteristics.

11. The method of claim 1, wherein the recommended action is to activate at scale (run an ad campaign) a pairing of audience and advertising creative variant with threshold-graded preference scores and density of desirable customers includes deploying the advertising campaign to the audience segment in question using the selected advertising creative variant.

12. The method of claim 1, wherein the recommended action is to suppress a pairing with below threshold preference scores or density of desirable customers includes reducing or eliminating advertising spend on that pairing or deploying a different advertising creative variant to that audience.

13. The method of claim 1, further comprising a recommended action to pause a pairing by performing additional data analysis to identify a different audience with higher preference scores and density of desirable customers or a different advertising creative variant.

14. The method of claim 1, wherein the attributes related to low CAC and high LTV are weighted based on a client preference and combined to create a composite customer potential score for each survey respondent.

15. The method of claim 1, wherein the recommended action to activate a pairing with high preference scores and density of desirable customers includes increasing advertising spend on that pairing to capture a larger share of that audience segment.

16. The method of claim 1, wherein the recommended action to suppress a pairing with low preference scores or low density of desirable customers includes diverting advertising spend to other pairings with higher preference scores and density of desirable customers.

17. A method for testing advertising, said method comprising the steps of:
recruiting prospective survey respondents within a single online platform for collecting inputs from the respondents regarding an advertising creative preference, tracked for at least one of a demographic or a customer potential of the respondents through at least one of survey questions and/or an advertising creative variant; and
combining the individual inputs from the survey respondents to compute at least one score related to the advertising creative variant preference, tracked for at least one of the demographic or customer potential of the surveyed respondents.

18. The method of claim 17, wherein the recommended actions include modifying the advertising message or creative based on the insights gained from the survey respondents.

19. The method of claim 18, wherein the recommended actions include cross-referencing the computed scores with external market data to determine the potential impact of the advertising campaign on the overall market share.

20. The method of claim 19, wherein the external market data is a media category score, wherein the score indicates survey response integrity.

21. The method of claim 18, wherein the recommended actions include optimizing the timing and placement of the advertising campaign based on the computed scores and external market data.

22. The method of claim 18, wherein the recommended actions include monitoring the effectiveness of the advertising campaign and making adjustments based on real-time data analysis.

23. The method of claim 17, wherein the individual inputs collected from survey respondents include data on their previous purchasing behavior for similar products or services.

24. The method of claim 17, wherein the individual inputs collected from survey respondents include data on their browsing or search history related to the product or service being advertised.

25. The method of claim 17, wherein the individual inputs collected from survey respondents include data on their psychographic characteristics such as personality traits or values.

26. A method for intra-platform segmentation, said method comprising the steps of:
collecting survey data from survey respondents within a single on-line platform, wherein said survey data includes the respondents' reaction to each creative variant and at least one question related to a demographic attribute of the respondents; and
computing scores based on the survey data and making recommendations for a campaign within the same on-line platform, wherein said scores determine the most optimal pairing of creative variant with an audience.

27. The method of claim 26, further comprising the step of deploying a creative campaign at scale based on the recommended pairing of creative variant and audience with high creative preference scores and density of desirable customers.
